(19) United States
(12) Patent Application Publication
(10) Pub. No.: US 2006/0087955 A1
(43) Pub. Date: Apr. 27, 2006

(54) Dual stack optical data storage medium and use of such medium

(75) Inventor: Ronald Joseph Antonius Van Den Oetelaar, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electrnocs N.V.

(21) Appl. No.: 10/539,369

(22) PCT Filed: Nov. 19, 2003
(86) PCT No.: PCT/IB03/05322

§ 371 Date: Jun. 15, 2005

(30) Foreign Application Priority Data
Dec. 19, 2002 (EP) 0208424.1

(51) Int. Cl. G11B 7/24

(52) U.S. Cl. 369/275.1; 369/283

(57) ABSTRACT

A dual stack optical data storage medium (30) for recording and reading by means of a focused radiation beam (29) is described. The beam enters the medium (30) through a first radiation beam entrance face (21). The medium has at least a first substrate (1a) with on at least one side of the first substrate (1a) a first layer stack (2), comprising a first information layer (3), a second layer stack (5), comprising a second information layer. The second layer stack (5) is present at a position more remote from the first radiation beam entrance face (21) than the first layer stack (2). A first transparent spacer layer (4) is present between the first layer stack (2) and the second layer stack (5). The first information layer (3) is a read only type layer or an organic write once type layer, and the second layer stack (5) consists of maximally three adjacent layers of an inorganic metallic material. In this way an optical data storage medium (30) is achieved which is compatible with a dual stack ROM version of said medium and which has a simple second layer stack (5).

The invention relates to a dual stack optical data storage medium for recording and reading by means of a focused radiation beam entering the medium through a first radiation beam entrance face, said medium having at least a first substrate with on at least one side of the first substrate:

a first layer stack, comprising a first information layer,

a second layer stack, comprising a second information layer, said second layer stack being present at a position more remote from the first radiation beam entrance face than the first layer stack,

a first transparent spacer layer between the first layer stack and the second layer stack.

The invention further relates to the use of such a dual stack optical data storage medium.

An embodiment of an optical recording medium as described in the opening paragraph is known from Japanese Patent Application JP-11066622.

Digital Versatile Disc read only (DVD-ROM) has proven to be a very successful optical storage medium. The DVD-ROM standard specification describes both a single-stack disk (type A; data capacity=4.7 GB) as well as a dual-stack disk (type C; data capacity=8.5 GB). A write once and/or rewritable medium, which is compatible with the type A and type C DVD-ROM standard, is highly desirable. Furthermore, a double-sided version of the single-stack disk (type B; data capacity=9.4 GB) and a double-sided version of the dual-stack disk (type D; data capacity=17.0 GB) are described. Recordable and/or rewritable media, which are compatible with the DVD-ROM standard, are highly desirable. Recently a new format has been introduced called Blu-ray Disc (BD) with even a higher storage capacity. This system uses a blue radiation beam wavelength and a relatively high numerical aperture of the focused radiation beam. For this format also write once (R) and rewritable (RW) versions will be introduced.

For the single-stack DVD (type A) a compatible recordable format (DVD+R) and a nearly compatible rewritable format (DVD+RW) have been defined. For the dual-stack DVD (type C), a compatible dual-stack recordable DVD(+R) medium based on dye materials is described in non-prepublished European Patent Application no. 02075226.7 (PHNL020086) filed by the present applicant. A dual-stack rewritable DVD(+RW) medium is also feasible, but it seems that such a medium cannot be made compatible with the DVD-ROM standard, because of the limited reflection and transmission of the rewritable materials, e.g. phase-change materials, that are used. The increase in data capacity of a dual-stack DVD+R compared to a single-layer DVD+R and its compatibility with read only standards are clear advantages. For the second layer stack, sufficient reflection and sufficient modulation are required for compatibility reasons. These requirements can be met using organic dye materials. However producing a second layer stack based on dye materials involves at least three deposition steps: 1) deposition of a (metallic) mirror, e.g. by sputtering; 2) deposition of a dye layer, e.g. by spincoating or evaporation; 3) deposition of a protective capping layer, e.g. by spincoating or sputtering. The use of an inorganic phase-change stack with dielectric interference layers, as commonly used in rewritable media such as DVD+RW, instead of a dye-based recordable stack is not very attractive from a cost point of view, due to the fact that it involves sputtering of at least four layers. Furthermore, meeting both the reflection and modulation specifications using this kind of inorganic recordable stack still remains an issue.

It is an object of the invention to provide a dual stack optical data storage medium of the type mentioned in the opening paragraph which is compatible with a dual stack ROM version of said medium and which has a simple second layer stack.

This object is achieved by a dual stack optical data storage medium according to the invention which is characterized in that the first information layer is one selected from the group of types consisting of a read only layer and an organic write once layer, and that the second layer stack consists of maximally three adjacent layers of an inorganic metallic material. Since no transmission requirement for the second layer stack exists, materials other than organic dyes may be used to meet the reflection and modulation requirements of the second stack. Of course, a stack based on such materials must be equally or more attractive than a stack based on organic dye materials from a production and/or cost and/or reliability point of view. The deposition of metal or alloy layers is a technique frequently applied and can generally be performed very efficiently in a sputtering apparatus dedicated to the subsequent deposition of layers of metals or alloys of metals. A trilayer may be deposited using a single sputtering apparatus. No shift from dry processing to wet processing is necessary for the deposition of the second stack. This is a clear advantage over the use of an organic dye layer, which cannot be deposited by a sputtering process. The applicant has recognized that a second layer stack design of the medium is possible using a stack of maximally three inorganic metallic layers which meets the requirements for such a stack in order to be compatible with a dual layer ROM version of said medium.

Applicant has further recognized that the problem with a dual-stack recordable, i.e. write once, medium is that prerecorded read only data, which a manufacturer would desire to put on such a medium, have to be written sequentially medium by medium. This problem is solved by providing a medium wherein one of the first and second information layers is a read only layer with preembossed information as, e.g., in a normal DVD-ROM. The applicant have further recognized that with a combination of different types of recording layers according to the invention it still is possible to achieve a dual stack medium compatible with e.g. the dual layer (=dual stack) DVD ROM standard. E.g. an important parameter of the type C DVD-ROM standard is the reflectivity of the storage layers, which must be between 18% and 30% for each of the two layers. Consequently, the first information layer closest to the radiation beam entrance face of a compatible dual stack DVD+R medium should have a high transmission, sufficient reflection and low absorption. These criteria can be met for a write once layer based on e.g. dye materials or a read only layer, but cannot be met for a metallic write once layer, which has a relatively high optical absorption. In other words, the first information layer is a write once, e.g. a dye based layer with a relatively low absorption, layer or read only ROM layer (low absorption), while the second layer stack is a stack according to the invention. It should be noted that for the first information layer any type of organic layer with a relatively low absorption at the radiation beam wavelength is suitable and that there is no restriction to dye layers specifically.

In an embodiment the second layer stack is a bilayer of a phase change alloy layer and a metallic reflective layer, the metallic reflective layer being present closer to the radiation beam entrance face than the phase change alloy layer. The inorganic second layer stack may consist of two sputtered layers, e.g. a phase-change layer with a metallic layer on top to enhance the reflectivity.

In an embodiment the metallic reflective layer mainly comprises Al. For the metallic layer, aluminum (Al) is of particular interest since it forms a very thin, closed and chemically inert aluminumoxide layer upon exposure to air or an oxygen environment, before bonding the second layer stack to the first layer stack. The specific properties of such an aluminumoxide layer eliminate the need to deposit an additional protective capping layer.

Preferably the phase change layer is an alloy comprising Sb and Te. A phase change layer of such a composition is relatively easy to deposit. A preferred composition is Sb₂Te₃, a stable compound of which material the properties are well known. The physical recording mechanisms of said inorganic stacks may include mark formation by alloying and/or phase-changing and/or sintering and/or segregation and/or bubble formation and/or ablation and/or hole formation at elevated temperatures during writing.

Preferably the thickness of the Al layer is selected from the range of 5-10 nm and the thickness of the phase change layer is selected from the range of 10-40 nm. Layer thicknesses in these ranges give optimal performance as far as writability, sensitivity and reflectivity. Writability e.g. concerns the modulation depth of written marks, i.e. the normalized difference in reflection between an unwritten portion of the stack and a written mark in the stack when read out by the spot of the focused radiation beam.

In a special embodiment the medium further comprises a second radiation beam entrance face opposite from the first radiation beam entrance face and

a third layer stack, comprising a third information layer selected from the group consisting of a read only layer and an organic write once layer,

a fourth layer stack, being present at a position more remote from the second radiation beam entrance face than the third layer stack, said fourth layer stack consisting of maximally three adjacent layers of an inorganic metallic material, and

a second transparent spacer layer between the third layer stack and the fourth layer stack. The maximum data capacity of a single-sided dual-stack optical data storage medium is limited, e.g. to 8.5 GB for DVD. In order to store two versions of a movie in DVD format, including extra features, on one disc, e.g. a full-screen and wide-screen version as is commonly done for movies distributed in the U.S., 8.5 GB of storage capacity is generally insufficient. Therefore a compatible double-sided dual-stack optical recording medium is proposed. The proposed medium is compatible with its read only version, e.g. the type D DVD-ROM standard and consequently has a doubled total storage capacity, e.g. 17.0 GB in case of the type D DVD-ROM.

For an optical data storage medium compatible with the dual stack DVD-ROM specification the effective reflection level of the stacks is at least 0.18 at a radiation beam wavelength of approximately 655 nm.

For an optical data storage medium compatible with the dual stack BD specification the effective reflection level of the stacks ranges from 0.04 to 0.08 for dual-layer BD-RW and 0.12 to 0.24 for single-layer BD-RW, at a radiation beam wavelength of approximately 405 nm.

The invention will be elucidated in greater detail with reference to the accompanying drawings, in which

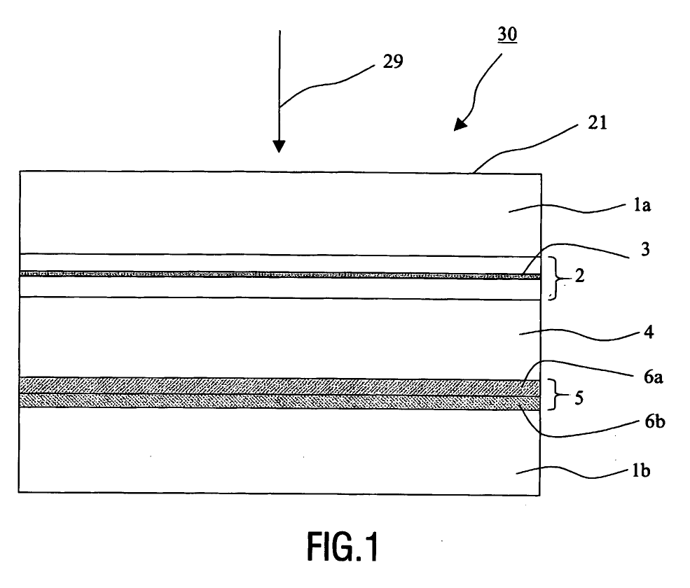

FIG. 1 shows a schematic layout of an embodiment of a dual-stack optical data storage medium according to the invention,

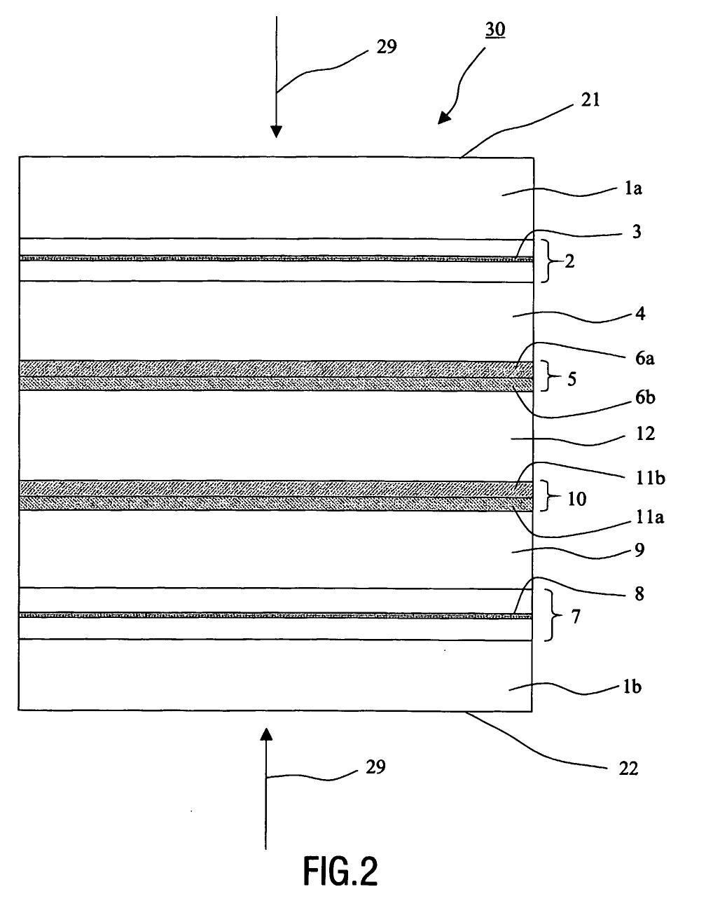

FIG. 2 shows a schematic layout of an embodiment of a double sided dual-stack optical data storage medium according to the invention,

In FIG. 1 a dual stack optical data storage medium 30 for recording and reading by means of a focused radiation beam 29 is shown. The radiation beam 29 enters the medium 30 through a first radiation beam entrance face 21. The medium has at least a first substrate 1a with on at least one side of the first substrate 1a a first layer stack 2, comprising a first information layer 3, a second layer stack 5, being present at a position more remote from the first radiation beam entrance face 21 than the first layer stack 2. A first transparent spacer layer 4 is present between the first layer stack 2 and the second layer stack 5. The first information layer 3 is a read only layer or an organic write once layer and the second layer stack 5 consists of maximally three adjacent layers of an inorganic metallic material. The embodiment will now be discussed in more detail.

Substrate 1a has a servo pregroove or guide groove pattern in its surface at the side of the first layer stack 2 and is made of polycarbonate (n=1.58) and has a thickness of 580 μm. The servo pregroove is used for guiding the focused radiation beam 29 during recording and/or read out. First layer stack 2 is a write once stack comprising a first information layer 3 made of a cyanine dye or azo dye (n=2.2; k=0.01) having a thickness of 90 nm. The dye may be deposited by spincoating or evaporation. A semi transparent reflective layer of Au (n=0.28; k=3.9) having a thickness of 8 nm is present between the first information layer 3 and the spacer layer 4 and deposited by e.g. sputtering. The first transparent spacer layer 4 is made of an UV-curable resin or a pressure-sensitive adhesive (PSA) (n=1.5) with a thickness of 40-60 μm. The second layer stack 5 is a bilayer of a phase change alloy layer 6b of Sb₂Te₃ (n=2.9; k=4.8) having a thickness of 12 nm and a metallic reflective layer 6a of Al (n=1.97; k=7.83) having a thickness of 6 nm. The metallic reflective Al layer 6a is present closer to the radiation beam entrance face 21 than the phase change alloy Sb₂Te₃ layer 6b. A second substrate 1b, made of polycarbonate (n=1.58) and having a thickness of 580 μm, is present adjacent the second layer stack 5. The substrate 1b has a servo pregroove or guide groove pattern in its surface at the side of the second layer stack 5.

The listed optical parameters n and k are for λ=655 nm which is the radiation beam wavelength. The calculated reflection and transmission are:

First Layer Stack 2:

Reflection (R1)=20%
Transmission (T1)=64%
Effective reflection from first layer stack 2:=R1=20%
   Second Layer Stack 5:
Reflection (R2)=62%
Effective reflection from second layer stack 5:=T1×T1×R2=25%
   The effective reflection of both layers is in full compliance with the DVD-ROM standard: 18%<R<30%.
   In a variant of this embodiment the first layer stack comprises a read only information layer. Such an information layer may e.g. be a 11 nm Au layer deposited in the pregroove pattern. In this case R1=22%, T1=61%, R2=62% and the effective reflection from second layer stack 5:=T1×T1×R2=23%.

Note that the substrate 1a may be replaced by a relatively thin, e.g. 100 μm, cover layer of a spincoated and cured UV curable material or a sheet of plastic with a pressure sensitive adhesive (PSA). Such a cover layer is e.g. used for the high density BD version of the optical data storage medium.

In FIG. 2 a double-sided dual stack optical data storage medium 30 is shown compatible with the type D DVD-ROM standard. Reference numerals 1a, 21, 2, 3, 5, 6a, 6b correspond to the description of FIG. 1. The first transparent spacer layer 4 is made of an UV-curable resin and has a servo pregroove or guide groove pattern in its surface at the side of the second layer stack 5. Substrate 1b of FIG. 1 is replaced by a coupling layer 12. The medium further comprises a second radiation beam entrance face 22 opposite from the first radiation beam entrance face 21 for recording and reading in a third layer stack 7, comprising a third information layer 8 selected from the group consisting of a read only layer and an organic write once layer, and a fourth layer stack 10, being present at a position more remote from the second radiation beam entrance face than the third layer stack 7. The fourth layer stack 10 consists of maximally three adjacent layers of an inorganic metallic material.

A second transparent spacer layer 9 is present between the third layer stack 7 and the fourth layer stack 10. The layers and stacks 1b, 7, 8, 9, 10, 11a and 11b are identical to respectively the layers and stacks 1a, 2, 3, 4, 5, 6a, 6b. Hence a dual sided dual stack medium is provided with identical design on both sides bonded together by coupling layer 12 which may be a PSA with a thickness of 20-300 μm. Depending on the thickness of the substrates 1a and 1b and the spacer layers 4 and 9, the thickness of the coupling layer 12 may be adjusted in order to have the total thickness of the medium 30 not exceed the maximum thickness as specified in the DVD disk standard, i.e. 1500 μm. The thickness range of the substrate however is also limited in order to prevent occurrence of excessive optical aberrations in the focused radiation beam 29 used for reading and writing in the information layers.

The pregroove (or guide groove) of the second layer stack 5 and the fourth layer stack 10 may also be present in the coupling layer 12 in which case the coupling layer may constitute a sheet of plastic with pregrooves on both sides. In this case, spacer layers 4 and 9 may constitute an UV-curable resin or pressure-sensitive adhesive (PSA) without pregroove.

A dual sided BD version is also possible, in which case two cover layers are present at the position of substrate 1a and 1b of FIG. 2 and at least one substrate, e.g. 1a or 1a/1b, is present between the second and fourth layer stacks 5 and 10 instead of the coupling layer 12.

It should be noted that the above-mentioned embodiment illustrates rather than limits the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

According to the invention a dual stack optical data storage medium for recording and reading by means of a focused radiation beam is described. The beam enters the medium through a first radiation beam entrance face. The medium has at least a first substrate with on at least one side of the first substrate a first layer stack, comprising a first information layer, a second layer stack, comprising a second information layer. The second layer stack is present at a position more remote from the first radiation beam entrance face than the first layer stack. A first transparent spacer layer is present between the first layer stack and the second layer stack. The first information layer is a read only type layer or an organic write once type layer, and the second layer stack consists of maximally three adjacent layers of an inorganic metallic material. In this way an optical data storage medium is achieved which is compatible with a dual stack ROM version of said medium and which has a simple second layer stack.

1. A dual stack optical data storage medium for recording and reading by means of a focused radiation beam entering the medium through a first radiation beam entrance face, said medium having at least a first substrate with on at least one side of the first substrate:
a first layer stack, comprising a first information layer,
a second layer stack, comprising a second information layer, said second layer stack being present at a position more remote from the first radiation beam entrance face than the first layer stack,
a first transparent spacer layer between the first layer stack and the second layer stack,
characterized in that the first information layer is one selected from the group of types consisting of a read only layer and an organic write once layer, and that the second layer stack consists of maximally three adjacent layers of an inorganic metallic material.

2. A dual stack optical data storage medium as claimed in claim 1, wherein the second layer stack is a bilayer of a phase change alloy layer and a metallic reflective layer, the metallic reflective layer being present closer to the radiation beam entrance face than the phase change alloy layer.

3. A dual stack optical data storage medium as claimed in claim 1, wherein the metallic reflective layer mainly comprises Al.

4. A dual stack optical data storage medium as claimed in claim 1, wherein the phase change layer is an alloy comprising Sb and Te.

5. A dual stack optical data storage medium as claimed in claim 3, wherein the thickness of the Al layer is selected from the range of 5-10 nm and thickness of the phase change layer is selected from the range of 10-40 nm.

6. A dual stack optical data storage medium as claimed in claim 1, wherein the medium further comprises a second radiation beam entrance face opposite from the first radiation beam entrance face and
a third layer stack, comprising a third information layer selected from the group consisting of a read only layer and an organic write once layer,
a fourth layer stack, being present at a position more remote from the second radiation beam entrance face than the third layer stack, said fourth layer stack consisting of maximally three adjacent layers of an inorganic metallic material, and
a second transparent spacer layer between the third layer stack and the fourth layer stack.

7. A dual stack optical data storage medium as claimed in claim 1, wherein the effective reflection level of the stacks is at least 0.18 at a radiation beam wavelength of approximately 655 nm.

8. Use of an dual stack optical data storage medium as claimed in claim 1, in an optical data storage device suitable for reading a dual stack ROM version of said medium.
